(19) United States
(12) Patent Application Publication
(10) Pub. No.: US 2007/0191181 A1
(43) Pub. Date: Aug. 16, 2007

(54) Method and apparatus for controlling vehicle rollback

(76) Inventor: Robert D. Burns, Lake Orion, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/352,831

(22) Filed: Feb. 13, 2006

(51) Int. Cl. B60W 10/00

(52) U.S. Cl. 477/40

(57) ABSTRACT

A system and method for maintaining a vehicle at a predetermined velocity on a graded surface is provided, which includes a propulsion system to supply motive torque to a vehicle wheel, a vehicle stability sensor, and a control system adapted to receive signal input from the vehicle stability sensor. The control system controls magnitude of the motive torque supplied to the wheel. The propulsion system may include an electric wheel motor powered by an electrical energy storage system, a hybrid powertrain system, and an internal combustion engine and transmission. The vehicle stability sensor determines orientation of the vehicle relative to a horizontal plane, including a longitudinal acceleration sensor and a virtual longitudinal acceleration sensor. The control system receives inputs from a wheel speed sensor, an accelerator pedal sensor, and a brake pedal sensor to control motive torque. Motive torque is controlled to maintain wheel speed sensor at a null output.

### TECHNICAL FIELD

This invention pertains generally to vehicle control systems, and more specifically to a system and method to maintain a vehicle at a substantially zero speed on a graded surface.

### BACKGROUND OF THE INVENTION

During a vehicle launch on an inclined surface there is the possibility of the vehicle rolling backwards when an operator does not responsively apply the accelerator pedal. The rollback distance is a function of how quickly the operator transitions from depressing the brake pedal to applying the accelerator pedal. For example, allowable rollback distance after 2 seconds elapsed time is shown for various grades, for an exemplary vehicle.

| | Rollback Distance after 2 seconds |
|---|---|
| Grade (%) | (in millimeters) |
| 7.2 | <20 |
| 11.6 | <80 |
| 16.0 | <160 |

Vehicles with automatic transmissions typically generate torque, via a fluidic torque converter, that provides forward motion as the brake pedal is released, referred to as creep torque. The effectiveness of this creep torque varies, and on steeper grades some systems may allow vehicle rollback.

In a conventional vehicle, the engine is running at idle, allowing a control system to provide creep torque upon brake pedal release. The prior art includes various systems and methods to accomplish vehicle hold on grade, to prevent rollback. One system, executed on a conventional internal combustion engine and powertrain engages a third clutching element in an automatic transmission to hold the transmission-output shaft from turning, thus preventing vehicle rollback. A second system senses vehicle roll via wheel speed sensors or transmission sensors, and modulates the engine throttle to increase torque output of the powertrain to hold the vehicle stationary on a grade. Both systems may accomplish the task of preventing vehicle rollback, but are applicable only on systems having fluidic torque converters incorporated into the powertrain. Furthermore, response time of such systems may lead to unacceptable performance.

In a hybrid vehicle the internal combustion engine is typically not running when the vehicle is at rest, to reduce fuel consumption. The typical hybrid vehicle does not have a torque converter and thus cannot provide a fluidically coupled engine torque to effect creep torque even when the engine is at idle during a vehicle stop. Different hybrids vary in the nature of the rollback allowed. Some provide no output torque and allow the rollback. Others may try to limit the rollback speed by applying regenerative torque at the output to resist the backward motion.

One method to address rollback in a hybrid vehicle includes increasing magnitude of the creep torque. This helps hold the grade on steep grades but provides too much acceleration on level surfaces. Therefore, it is desirable to add a variable amount of creep torque depending on the incline.

Many vehicles have an option for a vehicle stability system. The vehicle stability system generally adds one or more sensors to the vehicle to monitor vehicle orientation, including longitudinal acceleration. When stopped on a grade, the longitudinal acceleration sensor provides a reading that is mathematically related to the grade.

Therefore, a method and apparatus is desired to minimize or prevent vehicle rollback on grades. There is a need to provide creep torque to minimize vehicle rollback for a short period of time to allow the operator to transition from the brake pedal to the accelerator pedal, especially on hybrid vehicles. There is a need to provide a variable amount of creep torque, depending upon magnitude of vehicle incline.

### SUMMARY OF THE INVENTION

This invention offers an apparatus and method for measuring road grade, and adjusting the amount of creep torque, based on the grade. With a hybrid transmission, creep torque can be generated with an electric motor, providing a fast torque response. The advantage of this scheme is that the rollback is actively prevented and the operator is allowed time to transition from the brake pedal to the accelerator pedal. To conserve battery power it may be necessary to limit the amount of time that the rollback prevention torque is applied. This is accomplished by phasing out the rollback compensation after a period of time, as normal accelerator pedal control by the operator takes over.

By knowing the magnitude of the road grade, the controls are able to increase the creep torque in order to minimize or prevent vehicle rollback. Based on the grade the amount of motive torque required to hold the vehicle on the given grade is easily calculated. Such a scheme includes adequate failsafe schemes operation to ensure that added creep torque is not applied on level surfaces.

The advantage of this technique is that rollback is actively prevented. The vehicle does not have to begin rolling back before torque is applied. Another benefit is that a consistent creep feel can be attained on all grades if desired.

A system for maintaining a vehicle at a predetermined velocity on a graded surface includes a propulsion system operable to supply motive torque to at least one wheel of the vehicle, a vehicle stability sensor, and a control system adapted to receive signal input from the vehicle stability sensor and to control magnitude of the motive torque supplied to the wheel in response thereto. In accordance with certain aspects of the invention, the propulsion system may include non-limiting examples of at least one electric wheel motor powered by an electrical energy storage system, a hybrid powertrain system having a transmission system including an electric motor powered by an electrical energy storage system, and an internal combustion engine and transmission. In accordance with certain other aspects of the invention, the vehicle stability sensor is operable to determine orientation of the vehicle relative to a horizontal plane and may include such non-limiting examples as a longitudinal acceleration sensor and a virtual longitudinal acceleration sensor.

The control system of the invention may be further adapted to receive signal inputs from a wheel speed sensor, an accelerator pedal sensor, and a brake pedal sensor and to further control magnitude of the motive torque in response to at least one of the received signal inputs. A brake pedal sensor may include, for example a switch device indicating an operator request for braking or a linear device indicating an operator request for braking and a magnitude thereof. Furthermore, the control system may operate to control direction of the motive torque based upon signal inputs from the vehicle stability sensor, the wheel speed sensor, the accelerator pedal, and the brake pedal. Motive torque supplied to the wheel may be controlled to maintain the output from the wheel speed sensor at a substantially null output, when the predetermined vehicle velocity is substantially zero, the vehicle stability sensor indicates the vehicle is at a non-horizontal orientation, and, operator input to the accelerator pedal is substantially null. The magnitude of the motive torque supplied to the wheel may be decreased based upon predetermined conditions which may include, for example an elapsed time. The invention may be implemented, for example, in a front-wheel drive vehicle.

A method to maintain a vehicle at a predetermined velocity on a graded surface includes monitoring orientation of the vehicle relative to a horizontal plane, and controlling motive torque to at least one wheel of the vehicle based upon the orientation of the vehicle. In addition, the method may include monitoring accelerator pedal input, brake pedal input, and wheel speed, and further control the motive torque based upon at least one of accelerator pedal input, brake pedal input, and wheel speed. More particularly, the motive torque control may include determining the vehicle is at a non-horizontal orientation and accelerator pedal input is substantially null, and controlling energy supplied from an electrical energy storage system to control direction and magnitude of motive torque of an electrical motor operably coupled to the at least one vehicle wheel. Preferably, wheel velocity is maintained at a predetermined level. Preferably, motive torque is increased when the wheel velocity is substantially null, accelerator pedal input is substantially null, and brake pedal input is decreasing.

A method to control motive torque to at least one wheel of a vehicle having a propulsion system which includes an electrical energy storage system operable to power an electric motor for delivering the motive torque to the wheel includes determining vehicle velocity, operator command for acceleration, and operator command for braking force. Motive torque is then controlled based upon the vehicle velocity, the operator command for acceleration, and the operator command for braking force. The motive torque is preferably increased when the vehicle velocity is substantially null, the operator command for acceleration is substantially null, and the operator command for braking force is decreasing. Further, orientation of the vehicle relative to a horizontal plane is preferably monitored and motive torque is further controlled based upon the orientation of the vehicle.

These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a schematic diagram of a powertrain system, in accordance with the present invention; and,

FIGS. 2 and 3 comprise data graphs, in accordance with the present invention.

### DETAILED DESCRIPTION OF THE PREFERRED EMBODIMENT

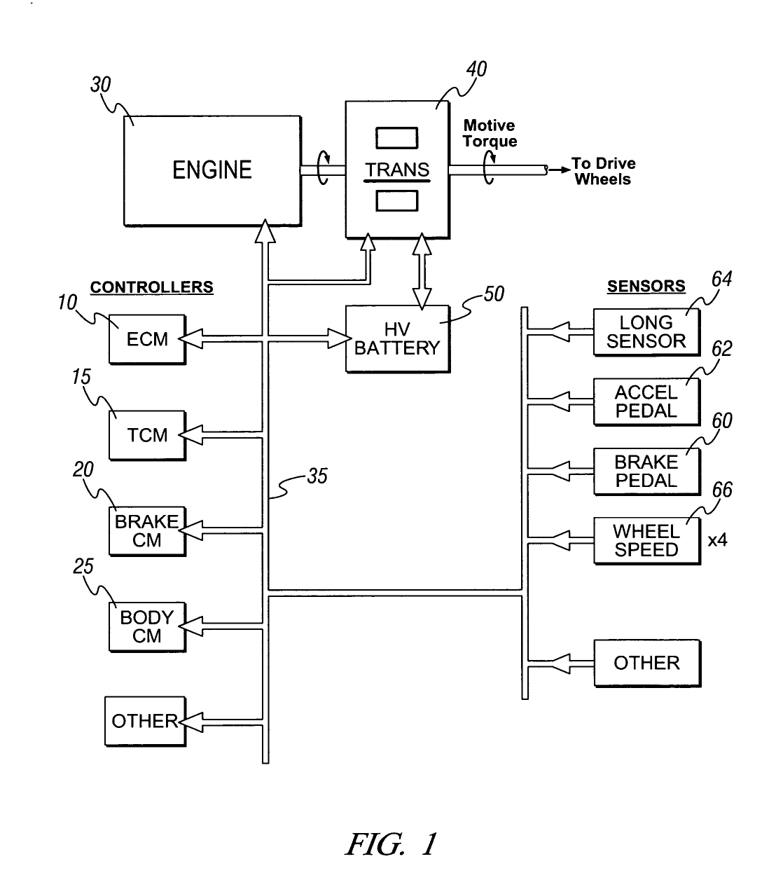

Referring now to the drawings, wherein the showings are for the purpose of illustrating the invention only and not for the purpose of limiting the same, FIG. 1 shows an exemplary powertrain control system for a vehicle which has been constructed in accordance with an embodiment of the present invention.

The exemplary vehicle comprises a multi-wheel vehicle for use in transporting persons or goods, and is typically a four-wheel vehicle having a propulsion system which drives at least one of the wheels. The exemplary propulsion system comprises a hybrid powertrain, including an internal combustion engine 30 operably connected to a hybrid transmission system 40, the output of which provides motive torque to one or more vehicle wheels. An electrical energy storage system 50, comprising a high voltage battery pack, is electrically coupled to the hybrid transmission system 40 to provide electrical energy to one or more electric motors contained therein. Either the internal combustion engine 30 and hybrid transmission system 40 or the electrical energy storage system 50 and hybrid transmission system 40 are operable to provide motive torque to one or more of the vehicle wheels, independent of each other or cooperatively. Alternatively, in a motor at wheel or motor at axle arrangement the electrical energy storage system 50 may be electrically coupled to one or more electric motors, to provide electrical energy thereto, which act to provide motive torque to the wheels. Hybrid and pure electric vehicle propulsion systems having an electric motor coupled to one or more of the vehicle wheels, including continuously variable transmissions, electric wheel motors, axle motors and various combinations of transmission devices with electric motors, are known to skilled practitioners, are not discussed in detail herein and all equally benefit from the application of the present invention. A control system is incorporated therein for controlling various aspects of the vehicle and the propulsion system, as is discussed hereinafter.

The exemplary vehicle is preferably equipped with various sensing devices and systems. This includes sensors for receiving inputs from an operator, including a brake pedal 60 and an accelerator pedal 62. The brake pedal 60 preferably includes a linear device having an output signal indicating an operator request for braking, or lack thereof, and magnitude of the operator request for braking. Alternatively or additionally the brake pedal 60 may include a brake switch, comprising a switch having a discrete output signal of either ON or OFF, and indicating an operator request for braking, or lack thereof. The accelerator pedal signal 62 comprises a linear device having an output signal indicating magnitude of operator request for acceleration, or an alternative device or system for sensing operator request for acceleration. The vehicle is further equipped with one or more wheel speed sensors 66, implemented on each of the vehicle wheels for purposes of brake and propulsion system management. Alternatively, transmission output speed may provide a signal indicative of vehicle speed. The brake pedal 60, accelerator pedal 62, and wheel speed sensor 66 each provide signal inputs to the control system. Details of the brake pedal 60, accelerator pedal 62, and wheel speed sensor 66 are known to a skilled practitioner, and not discussed in detail herein.

There is at least one vehicle stability sensing device 64, typically executed as an element of a vehicle stability system. The preferred vehicle stability sensing device 64 is a longitudinal acceleration sensor, comprising an accelerometer device operable to measure longitudinal acceleration of the vehicle. The longitudinal (front to back) acceleration sensor 64 is operable to measure the angle of the road grade on which the vehicle is operating, including when the vehicle is stopped. The preferred sensor 64 provides a signal output translatable to—0.16 g on a 16% grade, and has a minimal detectable reading of about 0.03 g on a 3% grade to allow for system and sensor diagnostics. The minimal detectable reading of about 0.03 g on a 3% grade is consistent with a control scheme and algorithm which operates to provide motive torque when the determined grade exceeds 4%. Alternatively, a virtual grade sensor may be executed as an algorithm in the control system to provide a grade sensor signal. A virtual grade sensor uses input from applied brake force, typically measured by output of the linear device associated with brake pedal 60 to determine brake pressure at zero miles per hour speed, hence, vehicle holding torque and vehicle grade.

The control system preferably comprises a known distributed control system having a plurality of controllers signally connected via a local area network (‘LAN’) 35 throughout the vehicle to accomplish various tasks. The exemplary control system includes engine controller 10, transmission controller 15, brake controller 20, and body controller 25 which are signally connected to the internal combustion engine 30, the hybrid transmission system 40, and the electrical energy storage system 50 via the LAN 35. Electrical energy storage system 50 includes energy storage apparatus as well as energy storage system control apparatus. Each of the aforementioned controllers is preferably a general-purpose digital computer generally including a microprocessor, ROM, RAM, and I/O including A/D and D/A. Each controller has a set of control algorithms, comprising resident program instructions and calibrations stored in ROM and executed to provide the respective functions of each computer. Information transfer between the various computers is preferably accomplished by way of a high-speed LAN bus, as previously mentioned.

The control system is signally connected to the aforementioned sensors and other sensing devices, and operably connected to output devices to monitor and control engine and vehicle operation. The output devices preferably include subsystems necessary for proper control and operation of the vehicle, including the engine, transmission, and brakes. The sensing devices providing signal input to the vehicle include devices operable to monitor vehicle operation, external and ambient conditions, and operator commands.

Control algorithms in each of the controllers are typically executed during preset loop cycles such that each control algorithm is executed at least once each loop cycle. Loop cycles are typically executed each 3, 6, 15, 25 and 100 milliseconds of ongoing vehicle operation. Other algorithms are executed in response to some form of interrupt signal sent to one of the controllers from one of the external sensors.

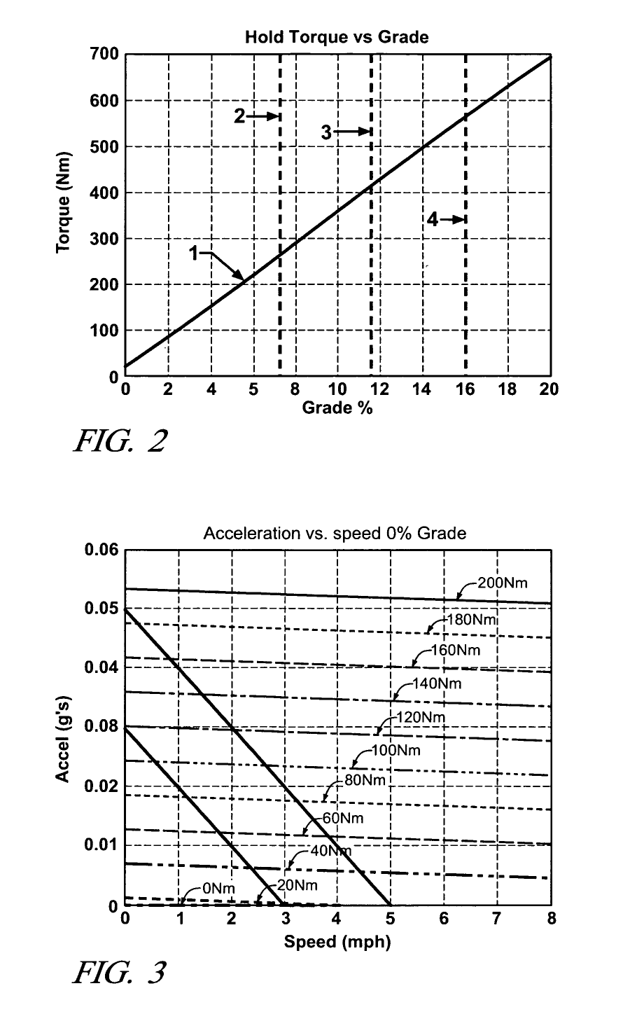

Referring now to FIG. 2, the amount of holding torque required to hold an exemplary vehicle on various grades is shown, wherein the x-axis is the road grade, measured in percentage off horizontal or zero grade, and the y-axis comprises the amount of holding torque, in Newton-meters (‘N-m’). Line 1 is representative of the amount of torque required to hold the exemplary vehicle static at a given grade. The exemplary vehicle with passenger load weighs 2863 kilograms (6300 lbs.), the tire static load radius is 0.379 meters (20 inches), and the vehicle has a final drive ratio of 3.08:1. A determinable amount of forward holding torque must be applied to the vehicle wheels during and after brake release to prevent rollback of the vehicle. The vertical lines correspond to exemplary grades, with corresponding holding torques, as follows Line 2—7.2% grade (265N-m), Line 3—11.6% grade (415N-m) and Line 4—16% grade (563N-m). A vehicle at 4% grade requires a holding torque of 155 N-m.

The system preferably acts by determining road surface grade based upon input from the longitudinal sensor 64, and applies holding torque, using the propulsion system to control magnitude of motive torque to the vehicle wheels. The applied holding torque comprises the creep torque compensated with a bias torque, which is based upon determined grade of the vehicle. The basic creep function determines creep torque, based upon the vehicle speed. This is determined by an algorithm in open loop control, and is independent of road grade. A calibration of creep torque is designed so that on level ground or horizontal plane (i.e., 0% grade) a specified acceleration versus speed profile is achieved. An exemplary 0% grade acceleration versus speed region is shown with reference to FIG. 3, comprising a plot of vehicle acceleration performance range as a function of speed and transmission output torque. At zero speed, a creep torque in a range of approximatelyl 120 N-m to 180 N-m meets a predetermined acceleration requirement, the requirement being illustrated with respect to an acceleration band between the solid lines in the figure. As vehicle speed increases, the torque limits of the range necessary to remain within the specified acceleration band decreases. The above applies to a specific vehicle configuration but a similar plot may be generated for any vehicle.

To meet a requirement of no rollback on a 4% grade, the creep torque should be at least 155 N-m for the exemplary vehicle, as shown with reference to FIG. 2. The creep torque cannot be increased much above 180 N-m without causing unacceptable acceleration of the vehicle when on level ground. Therefore the creep torque is preferably set at or near the 155 N-m range, and is compensated with bias torque when the road grade is greater than 4%. By setting the creep torque value for a road grade of 4%, the system is able to accommodate the minimal detectable sensor reading of about 0.03 g, or 3%, without introduction of errors due to sensor range and resolution and still provide acceptably limited level grade acceleration.

Knowledge of longitudinal acceleration simplifies determination of holding torque, and therefore a determination of creep torque, and bias torque, which comprises a difference between holding torque and creep torque. The longitudinal acceleration sensor 64 provides information on the grade prior to releasing the brake pedal. The creep torque is thus adjusted based upon measured grade.

The use of longitudinal acceleration sensor 64 allows the grade to be determined before the application of holding torque from the propulsion system to the drive wheels. Bias torque is added to the creep torque preferably when all of the following conditions are true: the brake pedal is depressed, the commanded brake force is decreasing, the accelerator pedal is not depressed, and the vehicle speed is zero, based on wheel speed sensor input. Under these conditions, on level ground, the accelerometer indicates an acceleration of zero. When the vehicle is stopped on a grade, the accelerometer reports an acceleration value proportional to the grade. The propulsion system applies a motive torque to vehicle wheels upon release of the brake pedal to reduce or eliminate rollback. When the braking torque is known, the system applies sufficient creep torque to ensure that the requisite holding torque, i.e. a combination of braking and propulsion, is applied on a given grade.

The system determines the road grade, and is thus able to determine holding torque. As force applied to the brake pedal is reduced, the bias torque is preferably increased so the motive torque to the vehicle wheels is maintained at the holding torque on the measured grade. Backup checks are preferably made to ensure vehicle acceleration is controlled when there is an offset in sensor readings.

Referring again to FIG. 2, a system may be executed wherein the propulsion system generates sufficient motive torque at the vehicle wheels to hold the vehicle at zero speed for a known, measured grade. Alternatively, a system may be executed to achieve a predetermined creep speed, regardless of grade, by compensating the creep torque value and the determined holding torque for a determined grade.

Additionally, the algorithm reads the measurement from the acceleration sensor 64 during braking and to calculate the holding torque as a function of grade and the creep torque as a function of speed. The maximum of the two values is applied, e.g. on grades less than 4% a normal creep torque is applied, and on grades greater than 4% the holding torque is applied. By adding the two values the control system maintains a similar acceleration/speed profile regardless of road grade.

Additionally, the value for holding torque may be multiplied by a factor that is inversely proportional to vehicle speed. As vehicle speed increases, the factor decreases, becoming less than one at some predetermined point. The holding torque output subsequently decreases, providing a built-in compensation for system errors, including accelerometer readings. When vehicle speed increases quickly, the holding torque is phased out rapidly to slow the vehicle.

Initiation of the algorithm for determining creep torque and holding torque requires knowledge of operator input to the brake pedal 60. Brake pedal position or input is preferred, thus allowing initiation of the creep torque algorithm before the brake pressure is fully released. This helps to reduce driveline noise or vibration. Alternatively, the system mechanized with a brake switch provides some functionality, albeit with more abrupt transitions. Ideally, the system knows the braking torque and phases in the rollback compensation torque to keep the total braking effort at the holding torque.

Duration of rollback compensation may be applied indefinitely. When application of the rollback compensation occurs indefinitely, it becomes equivalent to a hill holding function. This means holding the vehicle on the grade using the holding torque for as long as required. In this case, the rollback compensation ends when there is a request for torque from the operator through the accelerator pedal. This system is preferably executed in conjunction with the operator's use of brakes to prevent rollback. Additional safeguards may be built into the control system to address concerns created by prolonged use of the propulsion system to control vehicle, including internal combustion engine overheating, or exceeding battery state of charge limits.

Alternatively, the rollback compensation may be phased out after a finite amount of time. When acting to prevent rollback during the transition time of the operator's foot from brake pedal to accelerator pedal, the finite amount of time is limited in the range of two to three seconds. Rollback compensation torque is thereafter smoothly phased out to avoid any sudden torque changes.

The invention has been described with specific reference to the preferred embodiments and modifications thereto. Further modifications and alterations may occur to others upon reading and understanding the specification. It is intended to include all such modifications and alterations insofar as they come within the scope of the invention.

Having thus described the invention, it is claimed:

1. System for maintaining a vehicle at a predetermined velocity on a graded surface, comprising:
a propulsion system operable to supply motive torque to at least one wheel of the vehicle;
a vehicle stability sensor; and,
a control system, adapted to receive signal input from the vehicle stability sensor, and, control magnitude of the motive torque supplied to the wheel in response thereto.

2. The system of claim 1, wherein the propulsion system comprises a system having at least one electric wheel motor powered by an electrical energy storage system.

3. The system of claim 1, wherein the propulsion system comprises a hybrid powertrain system having a transmission system including an electric motor powered by an electrical energy storage system.

4. The system of claim 1, wherein the propulsion system comprises an internal combustion engine and transmission.

5. The system of claim 1, wherein the vehicle stability sensor is operable to determine orientation of the vehicle relative to a horizontal plane.

6. The system of claim 5, wherein the vehicle stability sensor comprises a longitudinal acceleration sensor.

7. The system of claim 5, wherein the vehicle stability sensor comprises a virtual longitudinal acceleration sensor.

8. The system of claim 1, wherein the control system is further adapted to receive signal inputs from a wheel speed sensor, an accelerator pedal sensor, and a brake pedal sensor.

9. The system of claim 8, wherein the brake pedal sensor comprises a switch device indicating an operator request for braking.

10. The system of claim 8, wherein the brake pedal sensor comprises a linear device indicating an operator request for braking and a magnitude thereof.

11. The system of claim 8, wherein the control system is further adapted to control magnitude of the motive torque in response to at least one of said received signal inputs.

12. The system of claim 11, further comprising the control system operable to control direction of the motive torque, based upon signal inputs from the vehicle stability sensor, the wheel speed sensor, the accelerator pedal, and, the brake pedal.

13. The system of claim 12, wherein the control system controls the motive torque supplied to the wheel to maintain the output from the wheel speed sensor at a substantially null output, when the predetermined vehicle velocity is substantially zero, the vehicle stability sensor indicates the vehicle is at a non-horizontal orientation, and, operator input to the accelerator pedal is substantially null.

14. The system of claim 1, further comprising the control system operable to decrease magnitude of the motive torque supplied to the wheel based upon predetermined conditions.

15. The system of claim 14, wherein the predetermined conditions comprise an elapsed time.

16. The system of claim 1, wherein the vehicle comprises a front-wheel drive vehicle.

17. Method to maintain a vehicle at a predetermined velocity on a graded surface, comprising:
monitoring orientation of the vehicle relative to a horizontal plane; and,
controlling motive torque to at least one wheel of the vehicle based upon the orientation of the vehicle.

18. The method of claim 17, further comprising:
monitoring accelerator pedal input, brake pedal input, and wheel speed; and,
further controlling the motive torque based upon at least one of accelerator pedal input, brake pedal input, and wheel speed.

19. The method of claim 18, wherein controlling motive torque comprises:
determining the vehicle is at a non-horizontal orientation and accelerator pedal input is substantially null; and,
controlling energy supplied from an electrical energy storage system to control direction and magnitude of motive torque of an electrical motor operably coupled to the at least one vehicle wheel.

20. The method of claim 19, wherein wheel velocity is maintained at a predetermined level.

21. The method of claim 20, wherein controlling the motive torque further comprises increasing the motive torque when the wheel velocity is substantially null, accelerator pedal input is substantially null, and brake pedal input is decreasing.

22. Method to control motive torque to at least one wheel of a vehicle, the vehicle having a propulsion system comprising an electrical energy storage system operable to power an electric motor operable to deliver the motive torque to the wheel, comprising:
determining vehicle velocity, operator command for acceleration, and, operator command for braking force; and,
controlling the motive torque based upon the vehicle velocity, the operator command for acceleration, and the operator command for braking force.

23. The method of claim 22, wherein controlling the motive torque comprises increasing the motive torque when the vehicle velocity is substantially null, the operator command for acceleration is substantially null, and the operator command for braking force is decreasing.

24. The method of claim 23, further comprising:
monitoring orientation of the vehicle relative to a horizontal plane; and,
controlling motive torque further based upon the orientation of the vehicle.
